(19) United States
(12) Patent Application Publication
(10) Pub. No.: US 2006/0248570 A1
(43) Pub. Date: Nov. 2, 2006

(54) CUSTOMIZED MEDIA PRESENTATION

(75) Inventor: George B. Witwer, Bluffton, IN (US)

Correspondence Address: BINGHAM MCHALE LLP, 2700 MARKET TOWER, 10 WEST MARKET STREET, INDIANAPOLIS, IN, 46204-4900, US

(73) Assignee: HUMANIZING TECHNOLOGIES, INC., Indianapolis, IN (US)

(21) Appl. No.: 11/164,694

(22) Filed: Dec. 1, 2005

Related U.S. Application Data
(63) Continuation-in-part of application No. 10/298,181, filed on Nov. 15, 2002.
(63) Continuation-in-part of application No. 10/298,182, filed on Nov. 15, 2002.
(63) Continuation-in-part of application No. 10/298,183, filed on Nov. 15, 2002.
(63) Continuation-in-part of application No. 11/064,992, filed on Feb. 24, 2005.

(51) Int. Cl. H04N 7/16; G06F 3/00; G06F 13/00; H04N 7/173; H04N 5/445

(52) U.S. Cl. 725/135; 725/37; 725/100

(57) ABSTRACT

In one disclosed embodiment, multiple content sources are identified, and displays of content from those sources are positioned on a common display. Content source selections and display preferences persist between user sessions, and fresh content is displayed each time the content loads. The user's customized display draws multimedia content from one or more selected sources from a predetermined list. The compiled content is presented with other user-selectable content, either from a cache or as a substantially live feed, to a different viewing devices. In some embodiments, a single click opens a selected source in a predefined view in the common display. In others, video segments are stored locally to a viewer, then shown on a video display device while an on-demand stream is being buffered. In still others, a wizard assists a user in selecting from streams that may be viewed based on installed software, bandwidth constraints, and user-specified criteria.

### REFERENCE TO RELATED APPLICATIONS

Subject matter in this application relates to, and priority is claimed to U.S. patent applications Ser. Nos. 10/298,181, “Methods and Systems for Implementing a Customized Life Portal”; 10/298,182, “Customized Life Portal”; 10/298,183, “Method and System for Modifying Web Content for Display in a Life Portal”; and 10/961,314, “Clustering-Based Personalized Web Experience”; and 11/064,992, “User-Configurable Multimedia Presentation System.”

### FIELD OF THE INVENTION

The present invention relates to computer graphics processing and selective visual display systems. More specifically, the present invention relates to a system for displaying multimedia content.

### BACKGROUND

Digital transmission of multimedia content has long been increasing in popularity. Digital transmission enables design of systems with error checking and correction, encryption, and other management provisions that are appropriate for the context of the delivery. Many such systems, however, place most (or even all) aspects of playback under the control of the provider or content source. While such systems provide advantages for content production, users are left with less ability to control operation of the systems on their end.

There is thus a need for further contributions and improvement to multimedia display technology, especially as it relates to user experience and control.

### SUMMARY

It is an object of the present invention to provide improved media display, systems, methods, software, and apparatus.

It is another object of the present invention to provide an improved method for displaying multimedia content on a user-configured display.

Various forms of the present invention achieve these objects and others. In one embodiment, data is fetched from a content source identified in a library provided by a provider, though the content is not hosted by the provider, and is displayed with other content, retrieved from a second source that is not in a predetermined library provided by the provider. The identification of the selected data sources, as well as their relative placements in the display persist from one session to another. In some forms of this embodiment, playback states of multimedia content are also persistent between sessions.

Another embodiment of the present invention includes a simultaneous display of three or more multimedia streams, each with user-configurable size and position, and user control of playback (such as with play, pause, and stop controls).

Still another embodiment of the present invention is a device that includes a processor, memory, and software that the processor can execute to accept user identification of three or more digital video streams, retrieve each of the video streams via a digital video network, and simultaneously display each of the streams. This software can accept and carry out user instructions to position the display of each of the video streams, and accept and carry out user instructions to resize the display of each of the video streams. In some forms of this embodiment, the simultaneous display is achieved without need for a tuner.

Yet another embodiment of the invention is a method, including providing a list of sources for multimedia content, accepting a user selection of at least one source from the list of sources, accepting user identification of another content source (which identification is not limited to a predetermined list), and storing data that identifies the content sources. The stored data is then retrieved, and the content from the sources is obtained. The content is then displayed together in a single display. In one variation of this form, the user also indicates preferences for the source and relative positioning of the content streams in the unified display. These preferences are stored and retrieved with the content source information, and the display is generated in accordance with the user's indicated preferences. In some forms, when a stream has been selected and configured (on the user's LifePage as described in U.S. application Ser. No. 10/298,182, for example), or at least when a presentation view has been configured, a single action by a user in the user interface (such as a click of a mouse, or pressing a key or key combination) selects a stream, opens a sub-window having a size and shape that the user has earlier specified, connects the client computer to the content source, and displays the content in the sub-window. The user can then change the feed being displayed in that sub-window simply by clicking on an icon or other interface widget associated with the new feed.

In another embodiment a media bridge supplies media streams from a variety of sources, including web and IPTV feeds, internet content, cable and satellite set-top boxes (STBs), personal digital cameras, video cameras, VCRs, DVDs, TIVO units, stereo systems and the like, and feeds one or more of the streams to a display. The display coordinates a presentation of user-selected content from several sources (including the media bridge) together, and facilitates the user's manipulation of those elements on the personalized screen by moving, resizing, layering, and the like.

Another embodiment provides a subsystem in a branch of a video distribution network, where a storage device stores video segments in advance for display while an on-demand stream is buffering. The stored video segment(s) may be selected from a plurality of available segments on the basis of a user profile developed as a function of video segments (e.g., television shows) that have been watched, information accessed by a user's computer, documents user has worked on or viewed, personal information explicitly or implicitly entered by the user, and the like. When an on-demand stream is requested, buffering begins and one or more of the stored video segments is shown on a video display. The segment(s) that are shown may be selected randomly from the storage segments, has a function of the on-demand stream being requested, or based on a “best match” between the stored profiles and the stored video segments.

In another form, a “wizard” interface is provided for selecting from among multiple available media streams for streaming from the source to a processor. A list of available streams is read (such as by parsing a previously displayed web page) to identify available multimedia streams. The locally available streaming media software is automatically detected, and a stream from the list is selected as a function of the detected forms of streaming media software. In some variations, the selection is also a function of detected network bandwidth and/or user-specified criteria.

### BRIEF DESCRIPTION OF THE DRAWINGS

FIG. 1 is a block diagram of a multimedia retrieval and display system according to one embodiment of the present invention.

FIG. 2 is a sample display according to one embodiment of the present invention.

FIG. 3 is a flowchart describing the development of a display and user thereof in one embodiment of the present invention.

FIG. 4 is a block diagram of a multimedia retrieval and display system according to another embodiment of the present invention.

FIG. 5 is a block diagram of a multimedia storage, retrieval, and display system according to still another embodiment of the present invention.

FIG. 6 is a block diagram of a video distribution network according to yet another embodiment of the present invention.

### DESCRIPTION

For the purpose of promoting an understanding of the principles of the present invention, reference will now be made to the embodiment illustrated in the drawings and specific language will be used to describe the same. It will, nevertheless, be understood that no limitation of the scope of the invention is thereby intended; any alterations and further modifications of the described or illustrated embodiments, and any further applications of the principles of the invention as illustrated therein are contemplated as would normally occur to one skilled in the art to which the invention relates.

Generally, a computer is connected to a digital data network and a display device. A user selects sources of multimedia content, then configures the display of that content on the local display. In some embodiments, one or more other network-based sources of multimedia content are identified, and their streamed playback is juxtaposed with the playback of the other network-based content under the control of the user. In various embodiments described below, the positioning and playback of these multimedia streams is controlled by the user, and the user's preferences and selections are persisted between the user's sessions.

In this description, “multimedia content” refers to digital content that can be played to form a video and audio presentation. “Content” more generically refers also to text, audio-only material, HTML, and other electronically presentable material.

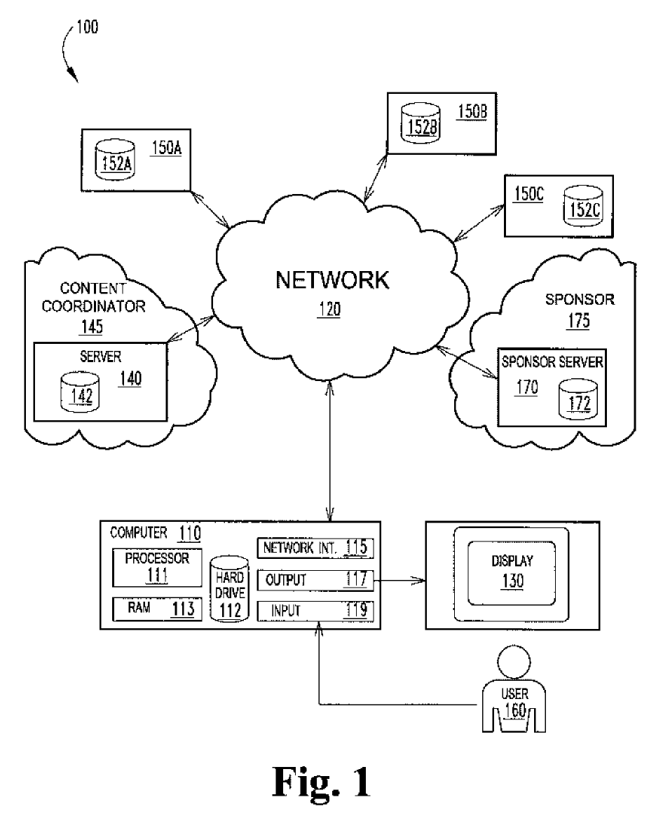

Turning specifically to FIG. 1, system 100 includes computer 110, which is connected to network 120 and display 130. Network 120 connects computer 110 to the content coordinator computer 140 and content source servers 150A, 150B, and 150C. Content coordinator computer 140 includes storage unit 142 and is controlled by a “content coordinator” entity 145, as will be discussed in further detail below. Content servers 150A, 150B, 150C each have their own respective storage devices 152A, 152B, 152C, respectively, but are not controlled by content coordinator 145. Sponsor 175 maintains another server 170 with its own storage device 172. User 160 uses the various input devices and observes display 130, as will be discussed in more detail below.

Computer 110 includes hard drive 112, processor 111, and memory 113, as well as network interface 115, output interface 117, and input interface 119, as are known by those skilled in the art. Power, ground, clock, sensors, and other signals and circuitry are not shown for clarity, but will be understood and easily implemented by those who are skilled in the art.

Processor 111 is preferably a microcontroller or general purpose microprocessor that reads its program from memory 113. Processor 111 may be comprised of one or more components configured as a single unit. Alternatively, when of a multi-component form, processor 111 may have one or more components located remotely relative to the others. One or more components of processor 111 may be of the electronic variety defining digital circuitry, analog circuitry, or both. In one embodiment, processor 111 is of a conventional, integrated circuit microprocessor arrangement, such as one or more PENTIUM 4 or XEON processors from INTEL Corporation of 2200 Mission College Boulevard, Santa Clara, Calif., 95052, USA, or ATHLON XP processors from Advanced Micro Devices, One AMD Place, Sunnyvale, Calif., 94088, USA.

Output device interface 117 provides a video signal to display 130, and may provide signals to one or more additional output devices such as LEDs, LCDs, or audio output devices, or a combination of types, though other output devices and techniques could be used as would occur to one skilled in the art. Likewise, optional input device 119 may include push-buttons, UARTS, IR and/or RF receivers, decoders, or other devices, as well as traditional keyboard and mouse devices. In alternative embodiments, one or more application-specific integrated circuits (ASICs), general-purpose microprocessors, programmable logic arrays, or other devices may be used alone or in combination as would occur to one skilled in the art.

Likewise, memory 113 can include one or more types of solid-state electronic memory, magnetic memory, or optical memory, just to name a few. By way of non-limiting example, memory 113 can include solid-state electronic Random Access Memory (RAM), Sequentially Accessible Memory (SAM) (such as the First-In, First-Out (FIFO) variety or the Last-In First-Out (LIFO) variety), Programmable Read Only Memory (PROM), Electrically Programmable Read Only Memory (EPROM), or Electrically Erasable Programmable Read Only Memory (EEPROM); an optical disc memory (such as a recordable, rewritable, or read-only DVD or CD-ROM); a magnetically encoded hard disk, floppy disk, tape, or cartridge media; or a combination of any of these memory types. Also, memory 113 can be volatile, nonvolatile, or a hybrid combination of volatile and nonvolatile varieties.

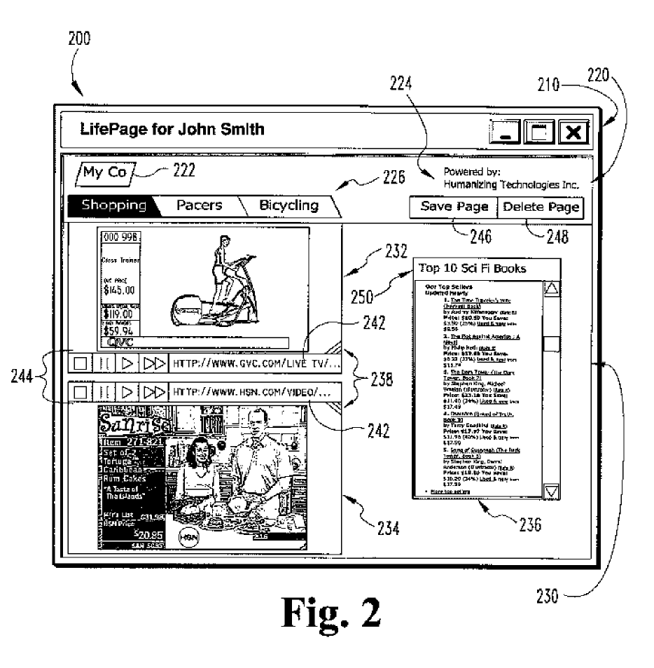

FIG. 2 shows an exemplary display according to one embodiment of the present invention. In some implementations of this embodiment, the display is created within a web browser window, building on technologies used for displays therein, while in others a custom, stand-alone application is provided to implement the techniques described below. As will be understood by those skilled in the art, a browser-based design leverages ubiquity of such technology, while the custom application enables the system to include additional features not readily available with standard browser technology.

FIG. 2 shows a LifePage display that has been customized by user 160 (“John Smith” for purposes of this discussion). Display 200 preferably includes a title bar 210 that identifies the user, reinforcing the user-centric nature of this embodiment. Header area 220 identifies the sponsor 175 for the page with logo 222, which may reflect sponsorship of an internet service provider (ISP), employer, or other entity. The content coordinator 145 is identified by designation 224, which reflects the entity that coordinates the content libraries and technology for use on LifePages such as these. In alternative embodiments, the sponsor indicated at 222 may also be content coordinator 145, so one or both of logo 222 and designation 224 may be omitted.

Tabs 226 are used to select collections of content and display parameters, which collections are typically organized in groups by general subject matter, here illustrated as including “Shopping,” “Pacers,” and “Bicycling,” which might be hobbies and interests of user 160. The selected collection at any given time may be indicated by shading or coloring of the background for the selected tab, changing the font of the label in the selected tab, darkening the border of the selected tab, or by other means as would be understood by those skilled in the art.

When a tab is selected, the associated plurality of content sources are polled, and the content is displayed in region 230 of display 200. In this example, region 230 displays a live video feed from the QVC shopping network at area 232, another live video feed from the Home Shopping Network (HSN) in area 234, and a live “top ten” list of science fiction books from Amazon.com in area 236. Each video feed is placed by the user by a drag-and-drop on a border of area 232, 234, or 236, and can be resized using sizing controls 238. The web address from which the feed is taken is shown in text controls 242, and playback of each stream is independently controlled using media controls 244.

As discussed further below, the relative (or absolute) position of each content area is saved either automatically at the end of each session, or manually when the user presses “Save Page” button 246. The collection of sources and positions can be deleted by user 160 by clicking on “Delete Page” button 248. It will be understood by those skilled in the art that other control configurations and user interface elements may be used to achieve the same or additional purposes without changing the underlying qualities of the present system.

Displays such as that shown in FIG. 2 are preferably developed by user 160, either from a pre-composed page or from scratch. The content coordinator 145 preferably provides a list of sources of multimedia and other content, including sources as shown in FIG. 2. In one mode of operation, the system provides a directory of sources by category and subcategory that the user can navigate via a GUI, and from which the user selects one or more sources. In the example shown in FIG. 2, areas 232 and 234 present content that originates from such a list. Though these sources are pre-selected by content coordinator 145, the actual selection, positioning, sizing, and playback are still within the control of user 160, as discussed herein.

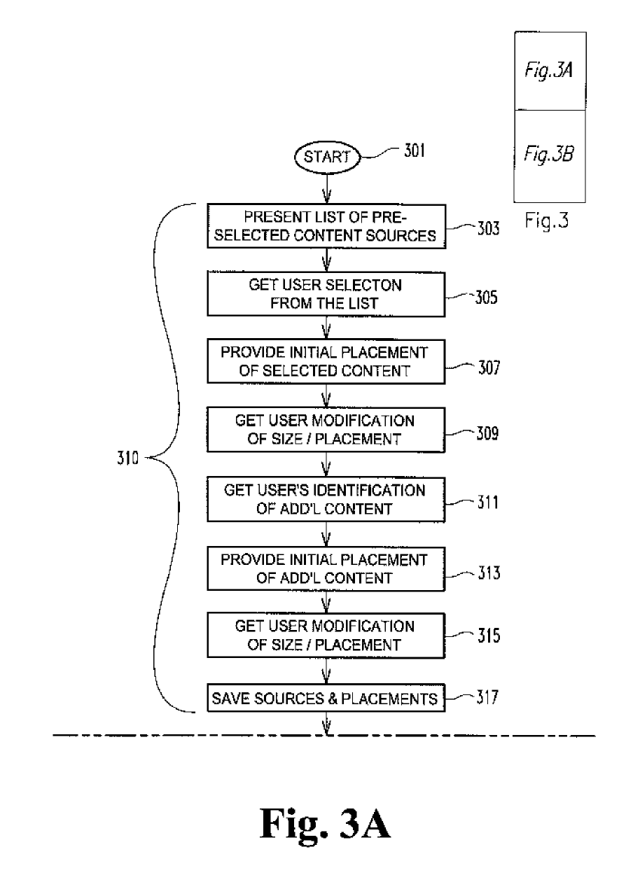

In contrast, the content shown in area 236 of display 200 is drawn from a source that is “manually” identified by user 160. For purposes of this disclosure, “manual identification” includes both direct entry of a URL by user 160 by typing, by drag-and-drop from a URL object source, or other method of selection from a broad universe of content that is not limited to a predetermined list that the content coordinator 145 gives the user 160, as will be discussed further below in relation to block 331 in FIG. 3. Like content from the pre-listed sources, however, the content displayed in area 236 can be positioned, sized, paused, stopped, and restarted according to the preferences of user 160.

The method executed in one embodiment of the present invention will now be discussed with reference to the flowchart of FIG. 3, with continuing reference to the components of system 100 in FIG. 1 and display 200 in FIG. 2. Method 300 begins at START point 301, typically after a user signs up for service. At block 303, the user is presented with a list of pre-selected content sources that have been determined by content coordinator 145 to be usable or desirable for use in a LifePage. For example, in this embodiment, the content sources in the list relate to a particular expressed interest of user 160, as determined from the context of the content identified therein, as well as technical compatibility between the format of content provided by that source and the framework itself. The user indicates a selection from the list at block 305, preferably by selecting that source with a pointing device and clicking a “next” button on the user interface to move forward with selection and placement.

The system then provides an initial placement of the selected content at block 307, preferably substantially filling the content display area 230, though not completely filling it. This preferred user interface technique implies to users that the display area is movable within display region 230. The content area includes a title bar 250 that functions as a handle for moving the content display area using a drag-and-drop gesture, as is understood by those skilled in the art. Resize control 238 is added to one or more corners of the content display area for resizing using similar dragging gestures. The user 160 may optionally modify the sizing and placement of the content area at input block 309 before adding more content to the display.

At block 331, the system allows user 160 to identify additional content for display on the LifePage. This identification may take the form of manual typing of a URL, dragging and dropping URL objects or data from other user interface sources, selection from a context menu bound to a hyperlink, or more complex view development as described in U.S. patent application Ser. No. 10/298,182. Other methods of selection (in block 305) and identification (in block 311) will occur to those skilled in the art, and may be used in this embodiment without undue experimentation.

The system provides initial placement of additional content in the new display area at block 313, preferably including a title bar and a resizing control as discussed above. The user may then optionally modify the size and placement of the new display area at block 315, and the system saves the content sources and the placement of the display areas at block 317.

User 160 may further modify the source selection and display layout before or after the sources and placements are saved, and more than two sources may preferably be identified, either as selections from the list of pre-selected multimedia content sources (as discussed at blocks 303 through 309) or by other identification means (as discussed at blocks 311 through 315). In preferred embodiments, the source selections and sizing and placement of content areas are automatically saved after each change, and the display is updated to show the content as placed by the user in substantially real time.

Further, those skilled in the art will appreciate that the user's preferences for source selection and display layout may be stored using one or more of a wide variety of methods. In one preferred embodiment, this data is stored by client-side software in one or more browser cookies, or in a configuration file (such as the registry in WINDOWS operating systems distributed by Microsoft Corporation). In alternative embodiments, the data is stored (in some cases redundantly) on content coordinator server 140 in storage 142, and/or on sponsor server 160 in storage device 162. Preferred embodiments also display freshly retrieved content from each source for display in the respective content display areas when each area is initially placed (see blocks 307 and 313 above), and update the content at regular intervals while the page is being displayed on device 130.

The steps 301-317 in method 300 just described comprise a first user session 310 wherein, generally speaking, the user picks content that he or she wishes regularly to see, and arranges that content as he or she desires. Later, in a second user session 320, those preferences are retrieved, the content is updated from the selected and identified sources, and the user's display is provided as will now be discussed.

When user 160 indicates a desire to view his or her LifePage, such as by opening a browser or custom application, or by navigating a browser to the LifePage, the LifePage framework is displayed at page 319. The selected content is retrieved at block 321, and the additional content is retrieved at block 323. Those skilled in the art will appreciate that the retrieval of content from a plurality of sources at blocks 321 and 323 may be accomplished in serial or in parallel, and will preferably include all content sources to be shown in the display. In preferred embodiments, the selected content retrieved at block 321 comprises one or more multimedia streams, which continue to be retrieved in a streaming fashion as other blocks in method 300 are processed.

The retrieved content is displayed at block 325 using the saved placement data, so that updated content is shown to user 160 with the size and position the user has indicated (for example, at blocks 309 and/or 315). The user may then provide additional instructions (such as by the pointer device gestures described above herein), and those instructions are interpreted at block 327, where the system determines whether the instruction changes the position or size of one or more content displays. If the instruction is a repositioning command, the details of the command are retrieved from the operating system at block 329, then are applied at block 331 by changing the position of the content area accordingly. Method 300 then continues by updating the display at block 337.

If the instruction interpreted at block 327 is a resizing command, the details of the command are obtained from the operating system at block 333, then applied at block 335 by changing the size of the content display area accordingly. Again, method 300 continues by updating the display at block 337. Those skilled in the art will appreciate that additional and different commands would be interpreted by the user interface in various embodiments.

The system then determines at block 339 whether more configuration commands have been received. If so, the system returns to block 327 so that another command can be interpreted and executed. If not, the configuration is saved at block 341, and the method ends at END point 399. It will be appreciated by those skilled in the art that in various embodiments the configuration can automatically be saved at one or more additional points in process 300, and that more user sessions will preferably be encountered. Some user sessions are likely simply to display the user's selected and identified content without any configuration changes. In other user sessions, the content display may be changed (as discussed in relation to user session 320), and content sources may be added to or removed from use in relation to the display.

In a preferred embodiment, the playback states of multimedia streams are saved at the end of each user session and restored at the beginning of the next session by that particular user. This way, if a user has chosen to pause or stop playback of a stream during one session, his or her preferences are also applied in the next session. In some embodiments, this data is preferably stored and retrieved as an array of states for the specified content, using one or more techniques that would occur to those skilled in the art. Certain of these embodiments save and restore the position of each stream, while others more simply stop a stream at the moment the new session begins if the stream was stopped or paused at the time the prior session ended.

Those skilled in the art will also appreciate that this preferred embodiment provides far greater freedom to users to select, arrange, and display content they want to see, as compared to many other “customizable home page” services that are known in the art. Furthermore, the use of pre-selected sources for multimedia content allows the content coordinator 145 to manage bandwidth, content, type, display technology requirements, and other demands and requirements of the system.

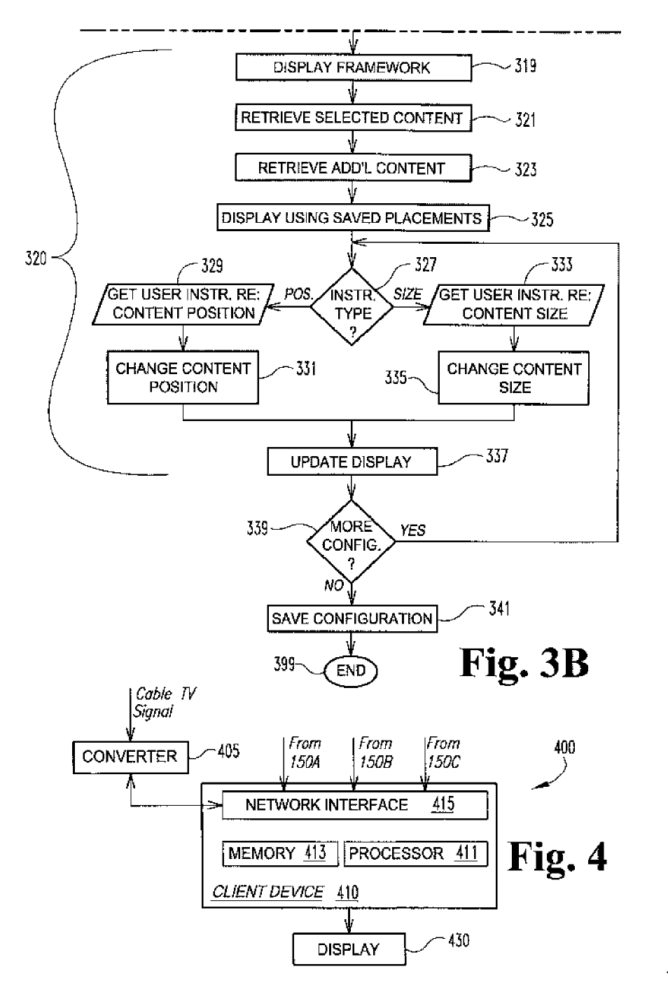

FIG. 4 illustrates an alternative embodiment of the present invention, and it will now be discussed with continuing reference to certain elements of FIG. 1. In this embodiment, multimedia content from a cable television feed can be displayed in conjunction with other selected and identified content as discussed above in relation to FIGS. 1-3. Here, a cable TV signal is accepted by a special converter 405 that converts the signal into one or more digital video streams. The streams are provided to network interface 415, which preferably forms a part of client-side device 405, analogous to computer 110 in FIG. 1. Client device 410 provides a video output signal for use by display 430, which displays the selected and identified multimedia streams for the user 160. Memory 413 in client device 410 is encoded with programming instructions executable by processor 411 to carry out a variation of method 300 (as was shown in FIG. 3). It is noted that processor 411 and memory 413 may be of any of the types discussed above in relation to processor 111 and memory 113, respectively. In some embodiments, processor 411 is of the same type as a processor 111 within the same broad system, while in others, different types of processors are used.

In system 400, video signals from content sources 150A, 150B, and 150C may be selected, sized, and positioned by the user, and video feeds arriving via converter 405 can be combined therewith into a single display on display device 430. Converter 405 preferably accepts digital and/or analog video signals for multiple channels via a single port, decodes selected channels from those carried on the signal, and provides digital video streams to client device 410 via network interface 415 for including in the display sent to display device 430. In this embodiment, the selection by user 160 of multimedia streams from the predetermined list preferably includes the option to use television channels from the cable TV signal in the display. When this option exists, and converter 405 is properly connected, client device 410 provides control information to converter 405 via network interface 415 so that the correct channel(s) can be converted to digital video. Converter 405 then sends the selected channels as video streams until circumstances no longer require them. Channel discovery and program guide information may be included in the content source list, arriving from content coordinator 145, through the cable TV signal, from an internet-based source, or from elsewhere as would occur to one skilled in the art.

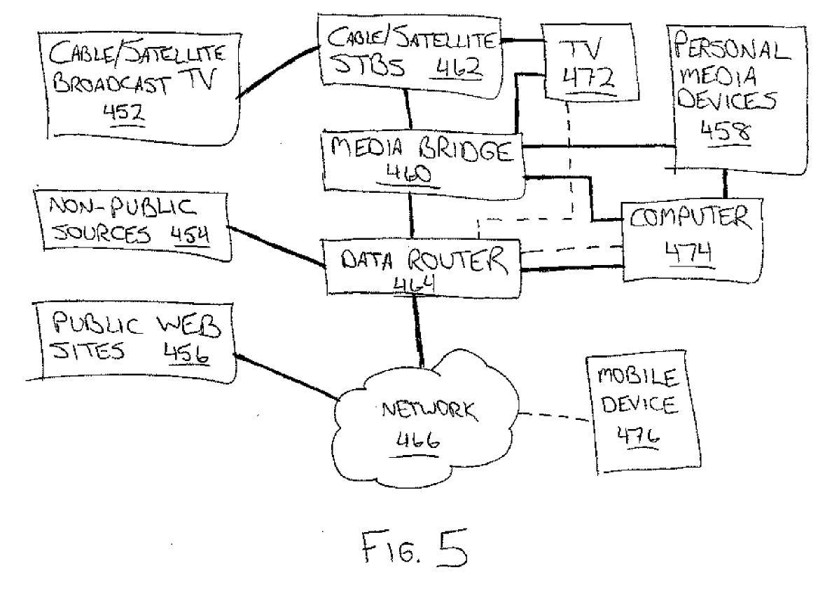

FIG. 5 is a block diagram describing data flow in yet another embodiment of the present invention. In this example, media content is generated (for purposes of this discussion) at cable and/or satellite broadcast television sources 452, nonpublic networks 454, public websites 456, and personal media devices 458. Other embodiments may include other content sources, such as cellular telephones, home audio systems, and the like. Cable and satellite broadcast sources 452 are received and decoded by set-top box(es) 462, while private web and IPTV feeds from sources 454 are received via modem, router, gateway, or other data routing device 464. Content from public websites 456 travels via network 466 and routing device 464 to media bridge 460. Likewise, set top box(es) 462 and personal media devices 458 also provide input to media bridge 460.

In various embodiments, signals from media sources may arrive via a wireless network access point, and Ethernet router, a set-top box for cable television or satellite television, a digital camera, a video camera, a portable digital audio player, a VCR, a DVD player, a digital video recorder, or some combination thereof. At least two physical input ports are provided, and are adapted for receiving signals simultaneously from at least three of these media sources, while at least two output ports are adapted for sending signals to any of a variety of media sinks, including a television, computer, and cellular phone. A source selection signal selects the media signal from among the sources, and a destination selection signal selects an output device from among the media sinks. A stream converter receives the source and destination selection signals, responsively converts the selected media signal into one or more output signals suitable for presentation on the selected device(s), and sends the output signals to the selected device(s). In some of these embodiments, the group of media sources is limited to an Ethernet router, a wireless network access point, a set-top box, a digital camera, a video camera, a portable digital audio player, and combinations thereof. This more limited approach saves on port costs and design complexity.

In other embodiments, the number of sources from which signals are simultaneously received is at least four. In these designs, the user has more flexibility to monitor and enjoy a variety of content streams that are substantially always available. In still other embodiments, the stream converter is implemented substantially completely in hardware, which has advantages in the available speed of conversion, but often makes upgrades and modifications somewhat more difficult. In alternative embodiments, the converter is implemented in software, which is sometimes slower, but provides more flexibility in correcting coding errors and upgrading features.

In still other embodiments, the system fetches additional data from the Internet and sends the output signals to the selected device(s) for presentation together with the fetched data. The fetched data is preferably selected by the user, so that the entire presentation consists of content identified by the user. In preferred embodiments, the presentation of the streamed, converted, media is then subject to user control with regard to size, position, and flow of playback.

In various embodiments, the user interface is configured so that the video “view” is similar in operation to that of a television. When the user takes a particular action in the user interface (such as by clicking a mouse button while a pointer is over a link or other graphical widget), a view is opened as the sub-window in the overall user interface. A connection is established to the media bridge 460, and the desired output signal is selected. The converted output of media bridge 460 is then displayed on the selected output device, and the user can position and size the sub-window to his or her liking. The window closes by specific user command (given, perhaps, using another interface widget) or when the whole application is closed. Either in this closing process or as configuration occurs, when the “TV view” is reopened, the configuration information is read and applied to the view, so that the source of that content screen is automatically reselected, and the size and position of the view matches those parameters of the TV view during the user's prior viewing. The user can select a different feed for display in the sub-window by taking another action (such as clicking another link or widget) that is associated with the new feed. The system then connects to the new feed and displays the feed.

In many embodiments the output devices initiate the flow of content streams using an HTTP request that includes the source selection, either as part of the URL or in POSTed data. The selection of destination may be explicit in the request data, implicit in the TCP wrapper for the HTTP request, implied by authentication information that is provided, or provided using other means as would occur to one skilled in the art. In some forms of this embodiment, the capabilities of the output device and/or the channel for transmission to it are also provided in the request for streaming information including, for example, screen resolution, available codecs, average bandwidth, peak bandwidth, alternative routing available, data formats, and user control features the output device has. These selection, capability, and authentication exchanges, as well as others, occur in various embodiments as will occur to those skilled in the art.

Media bridge 460 compiles the content from these various sources as selected by one or more users and presents it on a LifePage using formatting customized for each different display device. In hosted LifePage embodiments, the LifePage produced by the host is itself “public web content” within the meaning of this description, though it may be secured using methods known to those skilled in the art, and a variety of presentation devices have access to such a LifePage through network 466. In this example, each user's LifePage can be accessed using a television 472, computer 474, or mobile device 476, such as a cellular telephone or PDA. In these embodiments, the LifePage framework is delivered as an HTML page with one or more scripts and/or applets included in-line or by reference as will be understood in the art. Content from various sources (such as sources 452, 454, 456, and 458) is combined for presentation in the LifePage on any of the presentation devices 472, 474, or 476 just discussed. In some embodiments, a single presentation format is used for all devices, while in others, the form of LifePage on the wire is adapted to accommodate the capabilities of the particular device being used to access it. These accommodations include, for example, resolution and resizing modifications, bandwidth limitations, color depth adaptations, and the like. Still other adaptations are used in other embodiments.

In some alternative forms of this embodiment, media bridge 460 collects the content for presentation on the user's LifePages, hosting the content locally or caching it for retrieval by a user when the LifePage is retrieved. In other alternative forms, one or more content sources can be streamed substantially immediately upon receipt of the content by media bridge 460, so that the user's LifePage presents fresh content at all times. Sometimes a combination of live, external feeds and cached or self-posted content is presented, and in some embodiments audio and video streams are passed through live, while in others a delay or conversion operation occurs first.

In variations on these embodiments, content that is displayed in various content areas may come, as directed by the user, from internet-based multimedia feeds, decoded/converted cable or satellite television feeds, locally stored files (including, for example, video files, audio files, office documents, e-mail folders, and the like), RSS feeds, and other sources as would occur to one skilled in the art. Likewise, the library or list of content sources given by content coordinator 145 includes, in various embodiments, single-media content, multimedia content, streaming media, static content, dynamic content, and any combination thereof. Further, in various embodiments, a variety of client devices implement the present invention. For example, a general-purpose personal computer might be used with a monitor for display in one embodiment, while in other embodiments a television-based interface device (WEB-TV, for example) is used. In some devices, a PC-type operating system is used, while in others a different type of operating system is used, and in still others no distinct operating system is present.

In other variations, a plurality of sources, positions, sizes, and playback states selected by user 160 are stored and restored as a “collection.” User 160 defines, changes, deletes, selects, and manages multiple collections via a unified interface, such as through the use of tabs 226 (see FIG. 2) and other interface elements.

In still other variations, content of any streaming type for which the system has a suitable rendering engine is accepted by the system. The library of sources presented by content coordinator 145 (see FIG. 1) includes a variety of streaming media in some embodiments. In others, converter 405 accepts streaming content and provides one or more output streams for use in the disclosed system.

In yet other variations, when a stream has been selected and configured on the user's LifePage (as described in U.S. application Ser. No. 10/298,182, for example), or at least when a presentation view has been configured on a LifePage, a single action by a user in the user interface (such as a click of a mouse, or pressing a key or key combination) selects a stream, connects the client computer to the content source, and displays the content in a sub-window, or view, that has a size and shape that the user has earlier specified.

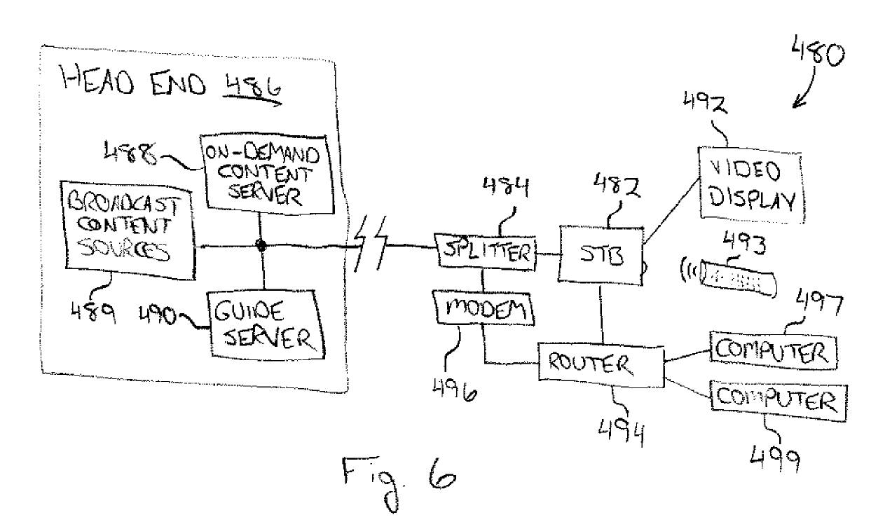

Another embodiment uses either a IPTV interface (described above) or a LifePage interface (shown in U.S. patent application Ser. No. 10/298,181) as a front end for on-demand content delivery in a broadcast (e.g., cable or satellite) television system, as shown schematically in FIG. 6. In an exemplary system 480, set-top box (STB) 482 is connected to a video distribution network via splitter 484 in a consumer's home using hardware that is well known in the art. In some embodiments, this is a cable television distribution network or satellite television distribution system. STB 482 receives data, broadcast content, and on-demand content streams from head end 486, which includes on-demand content server 488, broadcast content sources 489, and guide server 490, as well as other distribution and control equipment (for example, multiplexers, account management subsystems, encryption and/or scrambling equipment, and the like) not shown in FIG. 6. STB 482 includes one or more forms of local storage as would occur to one skilled in the art.

When used to view television programming, STB 482 receives distribution network signals and converts them to a form that can be processed by television, HDTV monitor, or other video display device 492 using demodulation, demultiplexing, decryption, and other conversion technologies suitable for use in the overall distribution system. Based on user input from remote control 493, STB 482 displays program guide information received from guide server 490, broadcast programming from broadcast content sources 489, and on-demand content streams from server 488. When a user navigates the interface and selects a particular on-demand content stream for local display, several seconds typically pass before the stream begins to be shown on video display 492 while the beginning of the stream is buffered in STB 482. During that buffering period, STB 482 presents one or more locally stored video segments targeted to the viewer. This “interim presentation” is, in various embodiments, an advertisement selected as a function of the stream being buffered and/or one or more user profiles. In some of these embodiments, profiles are developed as a function of the programming selections that have been made by the user (either over a predetermined period of time or substantially indefinitely), program guide selections, or other profiling inputs as would occur to one skilled in the art in view of the disclosure herein.

In the illustrated embodiment, STB 482 communicates with router 494 via a wired or wireless data link. Router 494 is also in communication with a network communication device (such as a cable modem) 496, which is connected to the video distribution system, which in turn is in communication with the internet by methods that would occur to one skilled in the art.

In this embodiment, router 494 also communicates using wired and/or wireless links with computers 497 and 499. As users operate computers 497 and 499, one or more profiles are generated of concepts that the user is interested in using the techniques described in U.S. patent application Ser. No. 11/064,992, for example. In some forms of this embodiment, the profiles are built using information that is sent to and/or retrieved from the internet via router 494. Profile information in raw or digest form is periodically sent to STB 482, which combines that information with the viewing selections of operators of remote 493 to form a composite profile that is used to select targeted ads for download at opportune times, such as when the flow of programming and data from head end 486 to home 487 is minimal. Then, when an on-demand stream is requested, the previously downloaded advertisement is presented during the buffering period.

Generally, the video segments that are shown during buffering periods are stored ahead of time in STB 482. Some forms of this embodiment use a “push” model of distributing the clips, while others use a “pull” model. In the “push” forms, head end 486 of the distribution network broadcasts a number of video segments through the network, and each STB 482 in the various branches of the network stores the segments most relevant to its own stored profile(s). This “best fit” is determined using any method that would occur to one skilled in the art, such as by clustering metadata about the segment or other information associated with the segment with the clusters that dominate a profile, and saving those that fit a cluster best. Where there are multiple profiles, one or more video segments may be stored for each profile. Alternatively, matching may be done by a schedule or prioritized order of advertisements.

In “pull” forms, STB 482 or one of computers 497, 499 collects profile information and occasionally transmits a request signal to the head end 486, either on a reverse path through splitter 484 and through the distribution network, by modem through a PSTN line, or using other means that would occur to one skilled in the art. The request signal (or a group of request signals collectively) contains profile information that is used by head end 486 to select one or more “best” video segments based on the profile information. The head end transmits the selected segments through the video distribution network to STB 482, which stores the segments for later display during one or more buffering periods. The profile information in the request signal(s) may include key words that characterize the user profile, for example, or exemplary documents that best represent the profile. In other systems, the full profile is sent and processed at the head end 486 to determine one or more segments to transmit. The selected segment(s) are unicast, or sent in a form addressed to the STB 482 with which the profile information is associated. This unicast is sent in one or more reply signals responsive to the request signals, though the reply signals may be separated in time based on other design priorities, such as a desire to defer the reply transmissions until low-volume times of day, for example.

In a variation of this embodiment, multiple video segments are identified as “best matches” for the variety of on-demand streams that are available in system 480, and those segments are stored locally in STB 482. The combination of this available stream information with the user's profile allows STB 482 to present segments that match both the user's profile and the selected stream being buffered.

In still other embodiments, a plurality of users use computers 497 and 499, and watch television 492. Using the clustering technology described in the U.S. patent application Ser. No. 10/961,314, system 480 is capable of establishing multiple profiles, or multiple concepts into which content is clustered. Video segments are selected that best fit those clusters, and they are downloaded during off-peak periods. Then, when an on-demand stream is requested, the best-fitting profile or conceptual cluster determines the clip that is shown. In an alternative form of this embodiment, characteristics of the clip itself are considered when determining that “best fit.”

Another feature of the present embodiment is a custom IPTV stream identification wizard that helps a user connect to an IPTV source using appropriate connection parameters. In one form, when a user is viewing a web page (using a stand-along browser with a LifePage portal, a browser embedded in the IPTV control interface, or another browsing facility as would occur to one skilled in the art), the user invokes the stream identification wizard. The wizard parses the HTML page to determine a list of available streams, and maintains information regarding the capabilities of the user's device. For example, an inventory of installed media players may automatically be taken (when the wizard is installed at invocation time, periodically, or at other times as would occur to one skilled in the art), thereby detecting which of two or more forms of streaming media software are installed, and the identified streams are filtered to include only those that are presentable by the available media players. In some embodiments, media player technology is included with the IPTV stream identification wizard, so that a known set of stream formats is available and can be selected by the wizard.

The wizard may also take into account bandwidth considerations (that is, by automatically detecting the bandwidth available between the stream source and the processor), selecting from different bit-rate streams based on that availability. In some embodiments, the wizard also determines available processing power for decoding the stream and considers that in the bandwidth- and format-selection decision. The wizard's recommendation can be overridden, or additional parameters can be specified by the user. Once a stream is selected, it is added to the user's collection of conveniently available streams, such as for display in a LifePage category.

All publications, prior applications, and other documents cited herein are hereby incorporated by reference in their entirety as if each had been individually incorporated by reference and fully set forth.

While the invention has been illustrated and described in detail in the drawings and foregoing description, the same is to be considered as illustrative and not restrictive in character, it being understood that only the preferred embodiments have been shown and described and that all changes and modifications that would occur to one skilled in the relevant art are desired to be protected.

What is claimed is:

1. A media presentation system, comprising a processor and a computer-readable medium readable by the processor, the computer-readable medium being encoded with programming instructions executable by the processor to:
present a user interface;
receive a first user action through the user interface;
responsively to the first user action:
open a view in the user interface;
begin to retrieve a first multimedia stream from a first multimedia stream source;
display the first multimedia stream in the view; and
accept user control over the size and position of the view;
receive a second user action through the user interface; and
responsively to the second user action:
begin to retrieve a second multimedia stream from a second multimedia stream source; and
display the second multimedia stream in the view.

2. The system of claim 1, wherein the programming instructions are further executable by the processor to:
save the size and position of the view; and
receive another instance of the first user action, and responsively thereto:
retrieving the saved size and position; and
opening the view in the user interface with the saved size and position.

3. In a video distribution system including a video distribution network, a subsystem comprising:
a video display in a branch of the video distribution network; and
a local storage device, in communication with the video display, that:
is in the same branch of the video distribution network as the video display, and
stores one or more video segments selected as a function of a user profile;
wherein, when retrieval of an on-demand stream from the video distribution network is initiated, the local storage device causes the video display to show at least one of the one or more video segments while at least a portion of the on-demand stream is being buffered.

4. The subsystem of claim 3, wherein the profile is a function of one or more video programs that have been watched on the video display.

5. The subsystem of claim 3:
further comprising a computing device configured to retrieve information based on user commands;
wherein the profile is a function of retrieved information.

6. The subsystem of claim 5, wherein the profile is a function of one or more video programs that have been watched on the video display.

7. The subsystem of claim 3, wherein:
the local storage device stores at least two video segments; and
causes the video display to show a selected one of the at least two video segments as a function of the on-demand stream being retrieved.

8. The subsystem of claim 3 in a video distribution network that has a plurality of branches that includes the branch in which the local storage device exists, wherein:
a plurality of video segments including the one or more video segments are broadcast to the plurality of branches before the retrieval of the on-demand stream from the video distribution network is initiated;
the one or more video segments are received in the broadcast and stored in the local storage device.

9. The subsystem of claim 3 in a video distribution network that has a head end, further comprising:
one or more request signals sent to the head end, where the request signals collectively contain profile information; and
one or more reply signals responsive to the request signals, each reply signal comprising a unicast of video segments, where the reply signals collectively include the one or more video segments;
wherein the local storage device receives the one or more reply signals and stores the one or more video segments.

10. A system for selecting a multimedia stream from among a plurality of available streams, comprising a processor and a memory in communication with the processor, the memory storing programming instructions executable by the processor to:
reading a list of multimedia streams available for streaming from a source to the processor;
automatically detecting which of at least two forms of streaming media software are stored in the memory;
selecting a stream from the list of multimedia streams as a function of the detected forms of streaming media software; and
storing information sufficient to access the selected stream.

11. The system of claim 10:
further comprising automatically detecting an amount of network bandwidth available for data transfer from the source to the processor; and
wherein the selecting is also a function of the detected network bandwidth.

12. The system of claim 10, wherein reading comprises parsing an HTML page.

13. The system of claim 10, wherein the selecting is also a function of one or more criteria provided by a user.
